(19) United States
(12) Patent Application Publication
(10) Pub. No.: US 2026/0321074 A1
(43) Pub. Date: Oct. 15, 2026

(54) Telematics-Enabled Trailer Safety and Monitoring System

(71) Applicants: David William Christ, Staunton, VA (US); Lynette Rene Christ, Staunton, VA (US)

(72) Inventors: David William Christ, Staunton, VA (US); Lynette Rene Christ, Staunton, VA (US)

(21) Appl. No.: 19/570,054

(22) Filed: Mar. 17, 2026

Related U.S. Application Data
(63) Continuation-in-part of application No. 19/030,775, filed on Jan. 17, 2025.

(51) Int. Cl. G07C 5/08; B60D 1/62; B60R 16/023; G07C 5/00

(52) U.S. Cl. CPC G07C 5/0825; B60D 1/62; G07C 5/006; G07C 5/008; B60R 16/0231

(57) ABSTRACT

A telematics-enabled trailer monitoring system is provided for detecting operational conditions of a trailer connected to a towing vehicle through a vehicle-trailer electrical interface. The system receives electrical signals associated with trailer circuits through a trailer connector or vehicle wiring harness and analyzes the signals using a monitoring module and processor to determine whether abnormal operating conditions exist during vehicle operation. The system may detect faults associated with trailer lighting circuits, trailer electrical power systems, and brake signal circuits. Monitoring information is transmitted through a telematics communication network to one or more monitoring platforms including driver interfaces, fleet monitoring systems, or remote compliance monitoring systems. The monitoring system may be implemented within a trailer monitoring device, a vehicle electronic control unit, or a telematics communication device associated with the towing vehicle. The system may also automatically detect trailer connection and initiate monitoring of trailer safety systems prior to and during vehicle operation.

### CROSS-REFERENCE TO RELATED APPLICATIONS

This application is a continuation-in-part of U.S. patent application Ser. No. 19/030,775, titled “Continuous Monitoring Trailer Adapter,” filed Jan. 17, 2025, the disclosure of which is incorporated herein by reference in its entirety.

### FIELD OF THE INVENTION

The present invention relates generally to vehicle safety monitoring systems. More particularly, the invention relates to telematics-enabled trailer monitoring systems capable of detecting electrical and operational conditions associated with trailers connected to towing vehicles.

The monitoring system may operate through vehicle wiring harnesses, trailer connectors, onboard monitoring modules, vehicle computer systems, and telematics communication networks to provide continuous monitoring of trailer operational conditions.

Monitoring information generated by the system may be transmitted through telematics networks to driver interfaces, fleet monitoring systems, and remote monitoring platforms where safety alerts and diagnostic information may be displayed.

The system improves driver awareness, vehicle safety, and operational reliability by enabling early detection of trailer equipment faults that might otherwise remain unnoticed during vehicle operation. By providing real-time monitoring and automated alert capabilities, the invention helps reduce accidents caused by trailer lighting failures, electrical faults, or other trailer equipment malfunctions.

The technology may be used across numerous industries including commercial transportation, freight logistics, construction, agriculture, municipal services, emergency response, and recreational vehicle applications, where improved trailer monitoring enhances road safety, regulatory compliance, and fleet maintenance visibility. The system may immediately alert drivers of safety concerns associated with trailer equipment faults, enabling corrective action before hazardous conditions occur.

The invention may be implemented on a wide variety of trailer platforms including semi-trailers, utility trailers, enclosed cargo trailers, refrigerated trailers, flatbed trailers, tanker trailers, agricultural trailers, equipment transport trailers, construction trailers, recreational vehicle trailers, travel trailers, and other towable vehicle platforms.

The monitoring system may also be implemented in government and defense applications including military transport vehicles, logistics trailers, and equipment transport platforms where continuous monitoring of trailer safety systems may improve operational awareness, safety, and equipment reliability.

### BACKGROUND OF THE INVENTION

Safe operation of trailers depends on the proper functioning of various trailer systems including lighting systems, electrical connections, braking signal systems, and power distribution components.

However, trailer system failures are common. Lighting failures, electrical connection faults, wiring damage, and other equipment malfunctions frequently occur during normal trailer operation and may remain undetected by drivers for extended periods of time, creating hazardous roadway conditions.

Current trailer inspection practices typically rely on manual pre-trip inspections or roadside enforcement inspections, which may not detect failures that occur during vehicle operation. Additionally, many vehicles provide limited feedback to drivers regarding the operational condition of connected trailers.

While certain vehicle diagnostic systems monitor the towing vehicle itself, they often do not provide comprehensive monitoring of trailer equipment, particularly when trailers are connected through conventional trailer connectors or wiring harnesses.

As commercial transportation increasingly relies on telematics systems, connected vehicle platforms, and fleet monitoring technologies, there is a growing need for systems capable of providing real-time monitoring of trailer operational conditions.

A telematics-enabled monitoring system capable of detecting trailer electrical faults, abnormal operating conditions, and equipment failures could significantly improve road safety, fleet maintenance visibility, and regulatory compliance.

Additionally, integration of trailer monitoring data with vehicle computer systems, fleet telematics platforms, and driver interface systems can provide drivers and fleet operators with early warnings of equipment failures, enabling corrective action before hazardous conditions occur.

Accordingly, there exists a need for an improved telematics-enabled trailer monitoring system capable of continuously monitoring trailer operational conditions and providing real-time alerts and diagnostic information to drivers and fleet monitoring systems.

The present invention provides a monitoring architecture capable of detecting trailer operational conditions prior to vehicle operation and during vehicle operation, thereby enabling automated pre-trip safety verification and continuous monitoring of trailer safety systems.

### SUMMARY OF THE INVENTION

The present invention provides a telematics-enabled trailer monitoring system capable of detecting electrical and operational conditions associated with trailers connected to towing vehicles.

The system may monitor electrical signals associated with trailer lighting systems, trailer electrical power systems, and electrical signals associated with braking systems.

The monitoring system may include a monitoring module, sensing interface, processor, and communication interface configured to detect abnormal operating conditions, electrical faults, and equipment malfunctions associated with trailer components. When abnormal conditions are detected, the system may generate alert signals and diagnostic information.

Monitoring information generated by the system may be transmitted through a telematics communication network to one or more monitoring platforms including a driver interface, a fleet management platform, or a remote compliance monitoring system.

In certain implementations, the monitoring architecture may detect trailer operational conditions prior to vehicle operation and during vehicle operation, thereby enabling automated pre-trip safety verification and continuous monitoring of trailer safety systems.

By enabling real-time monitoring and automated alert generation, the invention improves driver awareness, fleet maintenance visibility, and roadway safety while reducing the likelihood of accidents caused by undetected trailer equipment failures.

### Vehicle Integration

In certain embodiments, the trailer monitoring system may communicate with vehicle electronic control units, onboard vehicle diagnostic systems, or vehicle communication networks including Controller Area Network bus systems.

Through such integration, monitoring information associated with trailer operational conditions may be processed by vehicle systems and communicated to onboard driver displays or external telematics platforms.

This architecture enables the trailer monitoring system to operate as part of an integrated vehicle safety monitoring platform, allowing towing vehicles to automatically detect trailer system faults and generate driver alerts without requiring separate inspection procedures. Integration with vehicle communication systems further allows monitoring information to be transmitted to fleet management platforms and remote monitoring systems for diagnostic analysis and safety compliance verification.

In certain embodiments, the monitoring system may detect electrical characteristics of trailer circuits through the vehicle-trailer electrical interface without requiring modification of the trailer equipment itself.

In certain applications, the monitoring system may support compliance with vehicle safety regulations by providing automated monitoring of trailer lighting and other safety-related electrical systems during vehicle operation.

### BRIEF DESCRIPTION OF THE DRAWINGS

FIG. 1 illustrates a system overview of the telematics-enabled trailer monitoring system.

FIG. 2 illustrates a monitoring module architecture.

FIG. 3 illustrates signal detection and trailer circuit monitoring.

FIG. 4 illustrates monitoring of trailer electrical conditions.

FIG. 5 illustrates a driver alert interface configured to present fault notifications and receive a driver acknowledgment.

FIG. 6 illustrates alert devices including a visual indicator, an audible alarm, an in-cab alert display, and a remote alert module.

FIG. 7 illustrates an adaptive connector interface.

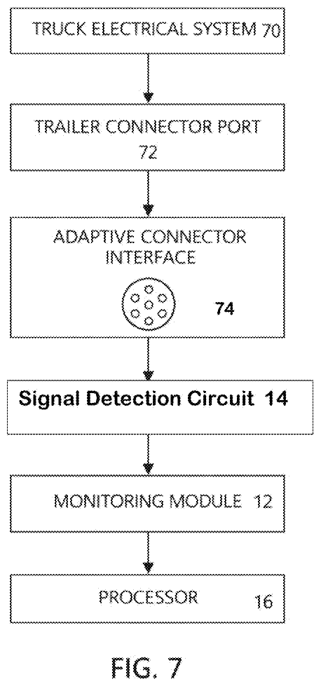

FIG. 8 illustrates telematics communication network architecture.

FIG. 9 illustrates implementation of the trailer monitoring system on a truck and trailer configuration.

FIG. 10 illustrates a portable monitoring device architecture connected to an electrical connector.

FIG. 11 illustrates communication of trailer monitoring information between trailer components, a server system, and a mobile device.

FIG. 12 illustrates an operational monitoring method including monitoring trailer signal lines, detecting signal failure, generating a fault alert, and transmitting the alert to a fleet management platform.

FIG. 13 illustrates a mobile driver alert interface displaying an alert notification.

FIG. 14 illustrates vehicle system integration including vehicle electronic control units and communication networks.

FIG. 15 illustrates compliance and telematics monitoring architecture.

FIG. 16 illustrates communication of trailer fault alerts from a monitoring device to a fleet management platform and a fleet manager device through a telematics network.

FIG. 17 illustrates a location monitoring method including detecting trailer location, communicating location information, and displaying location data.

FIG. 18 illustrates activation of alert devices by the monitoring system including in-cab displays and dashboard alert indicators.

### REFERENCE NUMBER LIST

Core Monitoring System
12—Monitoring module
14—Sensing interface/signal detection circuit
16—Processor
18—Communication interface
44—Diagnostic module
Truck/Trailer Interface
20—Electrical connector interface
22—Truck computer system
30—Trailer brake system
32—Brake signal sensor
40—Truck wiring harness
42—Trailer sensor module
70—Truck electrical system
72—Truck trailer connector port
74—Adaptive connector interface
Driver Alert System
26—Driver interface
50—-Visual indicator
52—Audible alarm
54—Remote alert module
56—Speaker
58—Alert devices
60—Alert display module
62—Fault message generator
64—In-cab display
66—Alert status confirmation
Telematics & Cloud
24—Telematics network
76—Telematics transmitter
82—Cloud server
84—Fleet manager
86—Location tracking module
88—Fleet management platform
89—Fleet manager device
Analytics & Dashboard
136—Alert dashboard
138—AI analytics module
Monitoring & Mobile
90—Monitoring device
100—Dashboard light
102—Fault alert
130—Mobile alert interface
132—Alert notification
Trailer System
150—Trailer systems
152—Compliance system
154—Fleet monitoring system
160—Trailer sensors
200—Trailer electrical systems
Method Steps
120—Monitor trailer signal lines
122—Detect signal failure
124—Communicate fault request
126—Determine alert priority
128—Transmit alert
Location System
140—Detect location
142—Communicate location data
144—Display location data

### DETAILED DESCRIPTION OF THE INVENTION

### System Overview

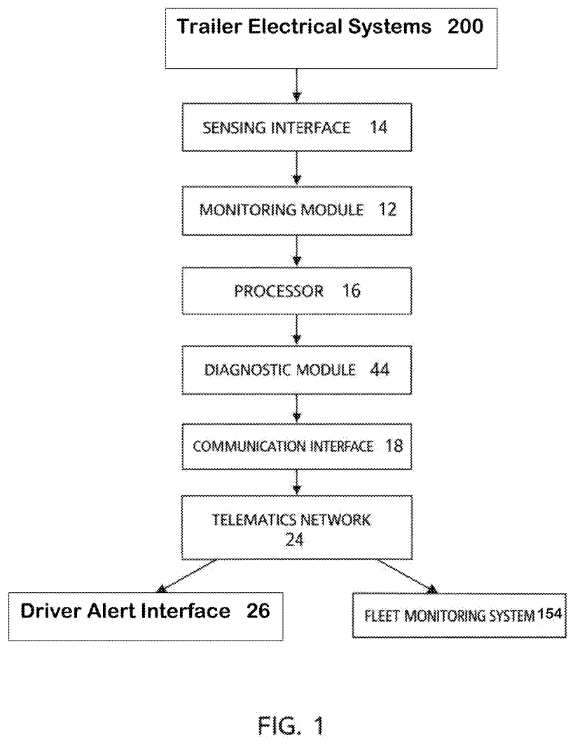

Referring now to FIG. 1, a telematics-enabled trailer monitoring system 10 is illustrated. The system 10 may be configured to monitor electrical and operational conditions associated with a trailer connected to a towing vehicle.

The monitoring system 10 may include a monitoring module 12, a sensing interface 14, a processor 16, and a communication interface 18. These components may be configured to detect operational conditions associated with trailer equipment and transmit monitoring information through a telematics communication network.

The system may communicate with a telematics network 24, which may transmit monitoring data to a driver interface 26, a fleet management platform 88, or other remote monitoring platforms.

### Trailer Connection Interface

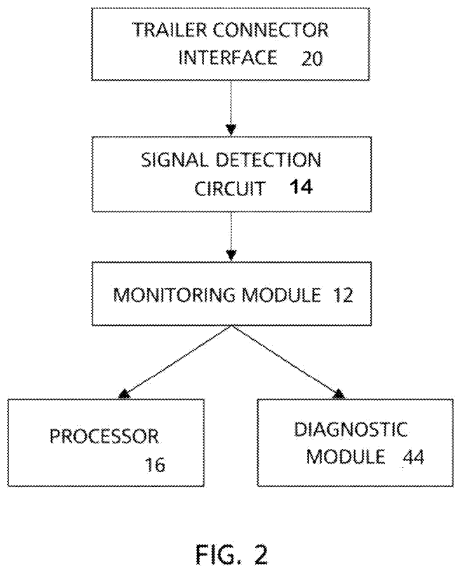

Referring to FIGS. 2-4, the monitoring system may be connected to a towing vehicle through a vehicle wiring harness 40 and a truck trailer connector 72.

In certain embodiments, an adaptive connector interface 74 may be provided to allow the monitoring system to interface with different trailer connector configurations used by various vehicle manufacturers and trailer types.

The monitoring system may receive electrical signals from trailer circuits through the trailer connector and wiring harness. These signals may represent operational conditions of trailer systems including lighting circuits and other electrical systems.

### Signal Detection and Monitoring

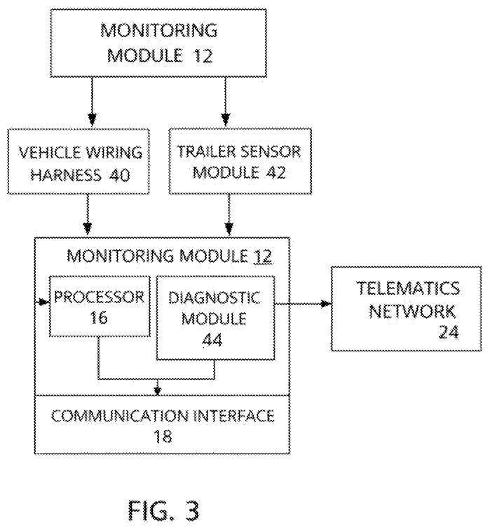

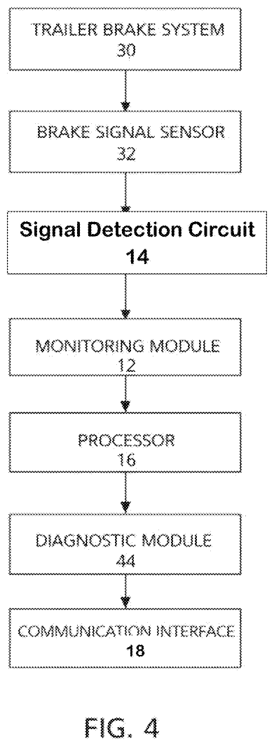

As illustrated in FIGS. 3 and 4, electrical signals received from the trailer connector may be processed through a signal detection circuit or sensing interface 14.

The sensing interface may detect electrical characteristics associated with trailer circuits including:
circuit continuity
voltage presence
abnormal electrical conditions
circuit faults or interruptions

The monitoring module 12 and processor 16 may analyze these signals to determine whether trailer systems are operating properly.

If abnormal operating conditions are detected, a diagnostic module 44 may generate an alert signal or diagnostic message indicating the presence of a trailer system fault.

### Telematics Communication

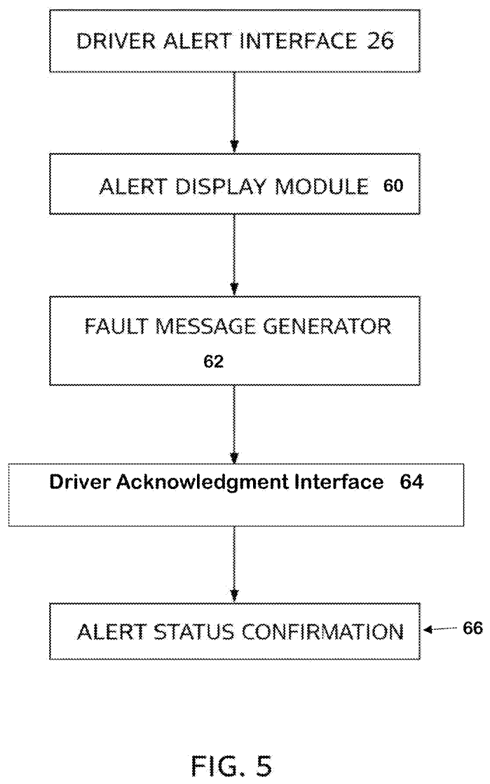

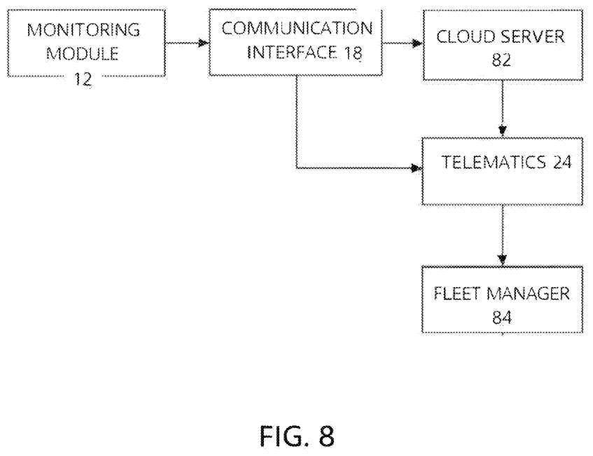

Referring to FIGS. 5 and 8, monitoring information generated by the monitoring system may be transmitted through the communication interface 18 to a telematics network 24.

The telematics network may include one or more communication technologies including:
cellular communication systems
satellite communication systems
wireless data networks
vehicle telematics platforms

Monitoring information may be transmitted through the telematics network to external monitoring systems including:
driver display interfaces
fleet monitoring platforms
maintenance monitoring systems
compliance monitoring systems

### Driver Alert Interface

Referring to FIG. 5, the driver interface 26 may include an alert display module, a fault message generator, a driver acknowledge input, and an alert status confirmation module.

When a trailer system fault is detected, the driver interface 26 may present a fault notification and may receive an acknowledgment from the driver, thereby confirming that the alert has been received.

### Alert Devices

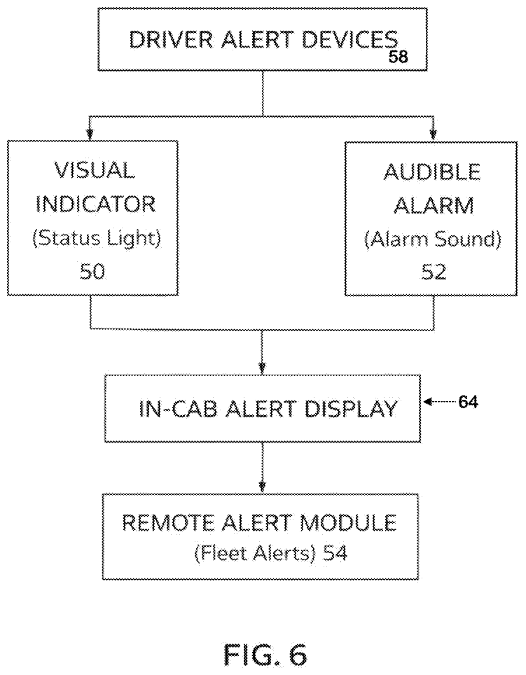

Referring to FIG. 6, the system may include alert devices 58 such as a visual indicator 60, an audible alarm 62, an in-cab alert display 64, and a remote alert module 66.

The alert devices 58 may be activated individually or in combination when abnormal trailer operating conditions are detected.

### Driver Alert System

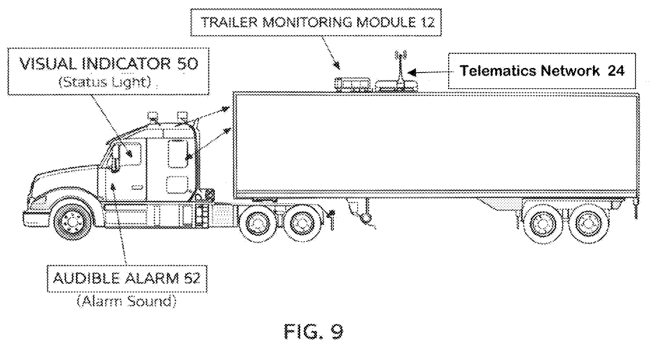

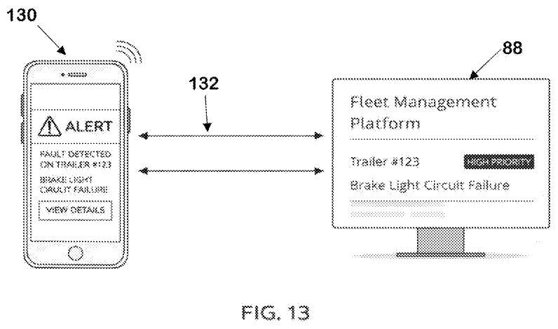

Referring to FIGS. 9 and 13, monitoring data generated by the system may be communicated to a driver interface 26.

The driver interface may include:
in-vehicle display systems
dashboard indicator systems
mobile device applications
telematics display systems

When a trailer system fault or abnormal operating condition is detected, the system may generate a driver alert notification indicating the specific condition detected.

This allows the driver to take corrective action before the condition creates a safety hazard.

### Truck and Trailer Implementation

Referring to FIG. 9, the trailer monitoring system may be deployed on a truck and trailer combination, with a monitoring module mounted proximate to the trailer connection and with telematics communication directed to a remote platform or mobile device.

This implementation illustrates how the system can provide both local driver alerts and remote fleet visibility while the vehicle is in operation.

### Portable Monitoring Device Architecture

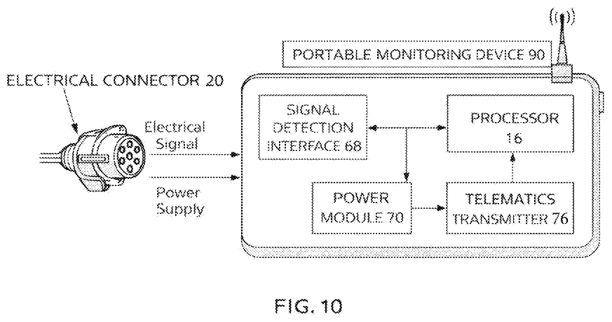

Referring to FIG. 10, a portable monitoring device may include an electrical connector 20, a signal input circuit 68, a power module 70, a diagnostic processor 76, and a telematics transmitter 78.

The power module 70 may provide operating power to the portable monitoring device while the signal input circuit 68 receives trailer signal information for analysis by the diagnostic processor 76. The telematics transmitter 78 may communicate fault or status information to remote systems.

### Monitoring Communication Architecture

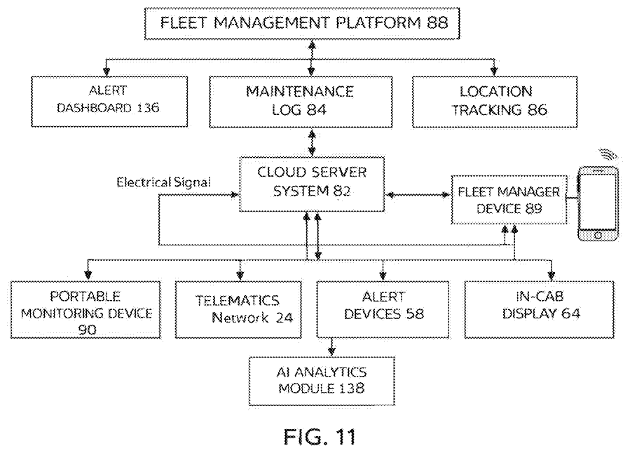

Referring to FIG. 11, trailer monitoring information may be communicated from trailer-based components to a server system and to a mobile device 94 or another user device.

This architecture allows fault information and operational status to be shared between vehicle-based equipment and external monitoring systems.

### Fleet Monitoring Integration

Referring to FIGS. 9-11, monitoring information generated by the trailer monitoring system may also be transmitted to a fleet management platform 88.

The fleet management platform may allow fleet operators to monitor trailer operational conditions remotely, receive maintenance alerts, analyze trailer diagnostic data, and track equipment performance.

This capability may improve fleet maintenance visibility and allow maintenance issues to be addressed proactively.

### Operational Method

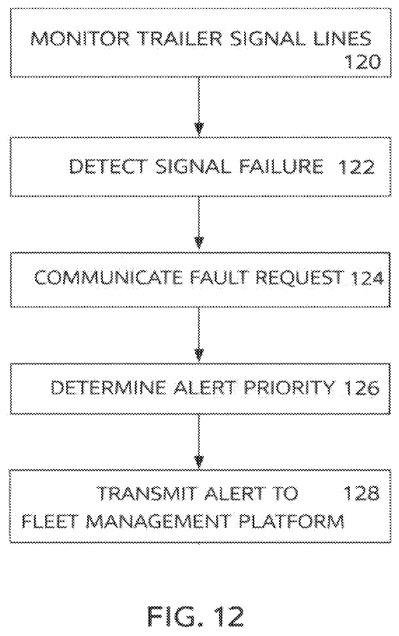

Referring to FIG. 12, a method of monitoring trailer systems may include monitor trailer signal lines step 120, detect signal failure step 122, communicate fault request step 124, generate fault alert step 126, and transmit alert to fleet management platform step 128.

The method may be performed before vehicle operation, during vehicle operation, or both, thereby enabling automated pre-trip verification and continuous monitoring of trailer safety systems.

### Mobile Alert Interface

Referring to FIG. 13, a mobile device 130 may display an alert notification 132 communicated from the monitoring system or from the fleet management platform 88.

The mobile alert interface may provide a user with fault details, status information, or acknowledgment options.

### Vehicle System Integration

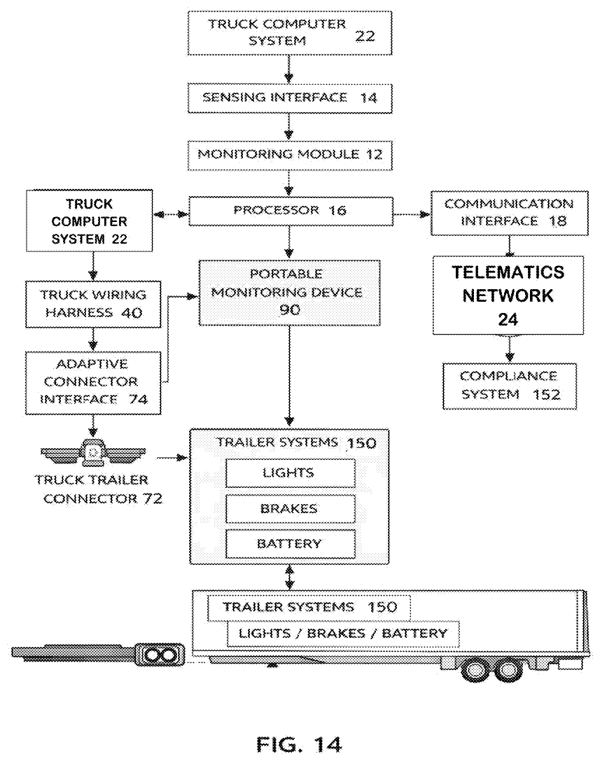

Referring to FIG. 14, the monitoring system may communicate with vehicle electronic control units 22, onboard vehicle diagnostic systems, or vehicle communication networks including Controller Area Network bus systems.

Through such integration, monitoring information associated with trailer operational conditions may be processed by vehicle systems and displayed through onboard vehicle driver information displays.

Integration with vehicle communication systems may allow the monitoring system to operate as part of a broader vehicle safety monitoring platform.

In certain embodiments, the monitoring system may detect electrical characteristics of trailer circuits through the vehicle-trailer electrical interface without requiring modification of the trailer equipment itself.

### Compliance and Safety Monitoring

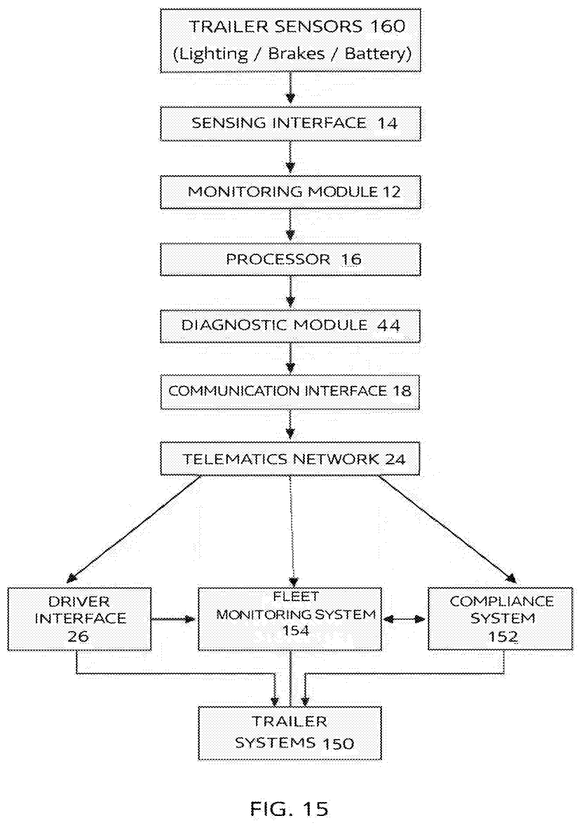

Referring to FIG. 15, monitoring data generated by the system may be transmitted to compliance monitoring systems 152 or other regulatory monitoring platforms.

In certain applications, the monitoring system may support vehicle safety compliance programs by enabling automated monitoring of trailer lighting systems and other safety-related electrical systems during vehicle operation.

By detecting faults in trailer equipment, the system may assist drivers and fleet operators in maintaining compliance with applicable transportation safety regulations.

### Remote Fault Alert Communication

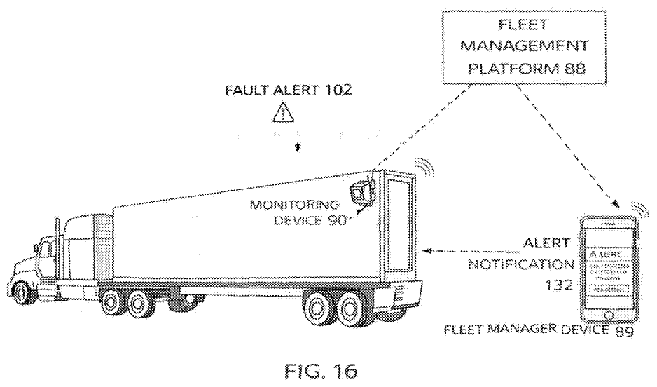

Referring to FIG. 16, the monitoring system may include a monitoring device 90 configured to detect trailer equipment faults and generate a fault alert 102.

The monitoring device 90 may communicate the fault alert through the telematics network 24 to a fleet management platform 88 and to a fleet manager device 89.

This architecture enables fleet operators to receive real-time notifications of trailer system faults and allows rapid response to equipment failures.

### Location Monitoring Method

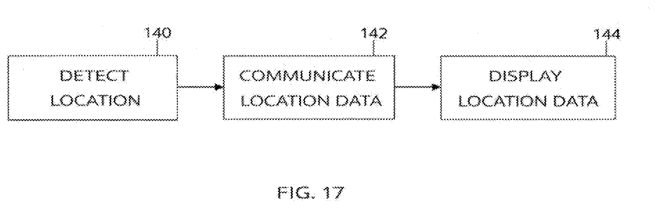

Referring to FIG. 17, the monitoring system may perform a location monitoring method including detect location step 140, communicate location step 142, and display location data step 144.

Location monitoring may allow fleet operators to track trailer locations and correlate equipment faults with operational or geographic conditions.

### Alert Device Activation

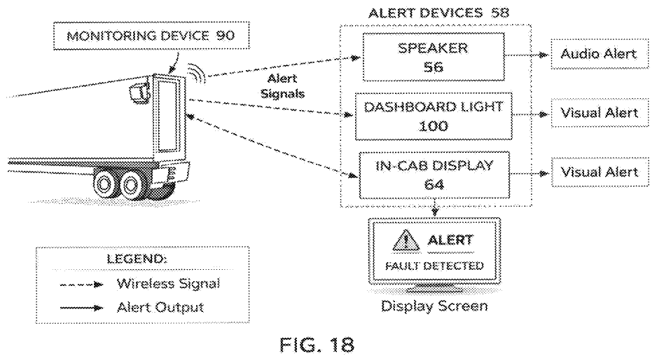

Referring to FIG. 18, the monitoring device 90 may communicate with one or more alert devices 58 when a trailer system fault is detected.

The alert devices 58 may include the visual indicator 60, the audible alarm 62, the in-cab alert display 64, the remote alert module 66, and a dashboard alert indicator 154.

When a fault alert is generated, the monitoring device 90 may activate one or more alert devices to notify the driver of a detected trailer system condition. Alert signals may also be transmitted to remote monitoring systems through the telematics network 24.

### Expanded Monitoring Architecture

In certain embodiments, the monitoring architecture may be implemented using distributed monitoring components located within a towing vehicle, within a trailer, or within external telematics or cloud-based monitoring platforms.

Monitoring functions may be performed by onboard monitoring modules, vehicle computer systems, trailer-based electronic modules, or remote telematics processing systems.

In some implementations, monitoring data associated with trailer electrical circuits may be transmitted to remote processing systems where diagnostic analysis, fault detection algorithms, or predictive maintenance analytics may be performed.

Such distributed monitoring architectures may allow the system to operate across multiple vehicle and trailer platforms while maintaining continuous monitoring of trailer operational conditions.

### Conclusion

The present invention provides a monitoring architecture capable of detecting trailer operational conditions prior to vehicle operation and during vehicle operation, thereby enabling automated pre-trip safety verification and continuous monitoring of trailer safety systems.

1. A telematics-enabled trailer monitoring system comprising:
a monitoring module configured to interface with a vehicle-trailer electrical connection; a sensing interface configured to detect electrical characteristics associated with one or more trailer circuits; a processor configured to analyze the detected electrical characteristics to determine operational conditions of one or more trailer systems; and a communication interface configured to transmit monitoring information and alert signals to at least one of a driver interface, vehicle system, fleet monitoring platform, or remote monitoring system; wherein the monitoring system is configured to detect trailer electrical characteristics through the vehicle-trailer electrical interface without requiring modification of the trailer equipment itself; and wherein the monitoring system generates an alert when an abnormal electrical condition associated with a trailer system is detected.

2. The system of claim 1, wherein the trailer circuits include lighting circuits.

3. The system of claim 1, wherein the monitoring system detects circuit continuity associated with trailer circuits.

4. The system of claim 1, wherein the monitoring system detects voltage presence associated with trailer circuits.

5. The system of claim 1, wherein the monitoring system detects abnormal electrical conditions associated with trailer circuits.

6. The system of claim 1, wherein the monitoring system monitors electrical signals associated with trailer braking signal circuits.

7. The system of claim 1, wherein the communication interface communicates monitoring data through a telematics communication network.

8. The system of claim 7, wherein the telematics network includes cellular communication systems.

9. The system of claim 7, wherein the telematics network includes satellite communication systems.

10. The system of claim 1, wherein monitoring information is transmitted to a driver interface.

11. The system of claim 10, wherein the driver interface includes a vehicle display system.

12. The system of claim 10, wherein the driver interface includes a mobile device application.

13. The system of claim 1, wherein monitoring information is transmitted to a fleet monitoring system.

14. The system of claim 13, wherein the fleet monitoring system provides maintenance alerts.

15. The system of claim 1, wherein the monitoring system communicates with a vehicle electronic control unit.

16. The system of claim 15, wherein communication occurs through a vehicle communication network.

17. The system of claim 16, wherein the vehicle communication network includes a Controller Area Network (CAN) bus.

18. The system of claim 1, wherein the monitoring system performs automated pre-trip safety verification.

19. The system of claim 1, wherein the monitoring system continuously monitors trailer conditions during vehicle operation.

20. The system of claim 1, wherein abnormal electrical conditions generate a diagnostic message.

21. The system of claim 1, wherein the monitoring system integrates with a telematics fleet management platform.

22. The system of claim 1, wherein monitoring information is transmitted to a compliance monitoring system.

23. The system of claim 22, wherein the compliance monitoring system evaluates trailer lighting operation.

24. The system of claim 1, wherein the monitoring system detects trailer system faults during vehicle operation.

25. The system of claim 1, wherein monitoring data is stored for diagnostic analysis.

26. The system of claim 1, wherein monitoring data is transmitted to remote maintenance systems.

27. The system of claim 1, wherein monitoring data is used for predictive maintenance analysis.

28. The system of claim 1, wherein the monitoring system interfaces with multiple trailer connector types.

29. The system of claim 1, wherein the monitoring system includes an adaptive connector interface.

30. The system of claim 1, wherein monitoring alerts are presented through vehicle dashboard indicators.

31. The system of claim 1, wherein monitoring alerts are transmitted to remote telematics platforms.

32. The system of claim 1, wherein the monitoring system operates without modification to existing trailer electrical wiring.

33. The system of claim 1, wherein monitoring information may be transmitted to multiple monitoring platforms simultaneously.

34. The system of claim 1, wherein the monitoring system is integrated into a towing vehicle electrical architecture or vehicle control system during vehicle manufacturing to enable factory-installed trailer safety monitoring functionality.

35. The system of claim 1, wherein monitoring data transmitted through the communication interface is processed by a remote telematics or software-based monitoring platform configured to analyze trailer system data using automated diagnostic algorithms or machine-learning models to detect abnormal trailer operating conditions and generate maintenance or safety alerts.

36. The system of claim 1, wherein the monitoring system is configured to detect a connection state between a towing vehicle and a trailer through the vehicle-trailer electrical interface and automatically initiate monitoring of one or more trailer systems without user input.

37. The system of claim 1, wherein the monitoring system is integrated into a vehicle electrical architecture or electronic control system of a towing vehicle and is configured to operate as a factory-installed system during vehicle manufacture.

38. The system of claim 1, wherein monitoring information generated by the monitoring system is transmitted to a compliance monitoring system configured to evaluate adherence to vehicle safety regulations based on detected trailer operating conditions.

39. The system of claim 1, wherein monitoring data transmitted through the communication interface is processed by a remote system configured to analyze trailer system data using automated diagnostic algorithms or machine-learning models to detect abnormal trailer operating conditions and predict potential system failures.

40. The system of claim 1, wherein the monitoring system detects trailer electrical conditions exclusively through existing electrical connections between the towing vehicle and trailer without direct access to internal trailer wiring components.

41. The system of claim 1, wherein the monitoring system correlates electrical signal behavior across multiple trailer circuits to determine a fault condition based on a pattern of signal anomalies.

42. The system of claim 1, wherein predictive analysis includes rule-based evaluation of electrical signal thresholds and historical fault patterns.

43. The system of claim 1, wherein the monitoring system directly measures electrical characteristics including voltage, current, or continuity of trailer circuits.

44. The system of claim 1, wherein the monitoring system operates independently of a vehicle communication network and directly detects electrical characteristics from the vehicle-trailer interface.
